(19) United States
(12) Patent Application Publication
(10) Pub. No.: US 2004/0242140 A1
(43) Pub. Date: Dec. 2, 2004

(54) Portioning device for foodstuffs

(75) Inventors: Gerd Scharninghausen, (US); Rene Dammand, (US)

Correspondence Address: WOOD, HERRON & EVANS, LLP, 2700 CAREW TOWER, 441 VINE STREET, CINCINNATI, OH, 45202, US

(73) Assignee: VEMAG Maschinenbau GmbH

(21) Appl. No.: 10/774,352

(22) Filed: Feb. 6, 2004

(30) Foreign Application Priority Data
Feb. 7, 2003 (DE) 203 01 908.3

(51) Int. Cl. A22C 11/02

(52) U.S. Cl. 452/35

(57) ABSTRACT

A portioning device for portioning foodstuffs such as sausage meat and dough. The portioning device includes a forming space filled by a means of the foodstuff and a cutting device for portioning the mass of foodstuff. The cutting device features a cutter that is introducible at least part way into the forming space to provide the portioning.

### FIELD OF THE INVENTION

The present invention relates to a portioning device for portioning pasty bulk material, in particular sausage meat, doughs or the like, with a forming space delimited by a wall section for shaping the mass, into which the mass may be filled, and having an outlet opening though which the portioned mass may be output.

### BACKGROUND OF THE INVENTION

Portioning devices of this type are known. They are used for portioning pasty bulk materials such as sausage meat, dough or other foodstuffs; in this respect reference is made below to product, mass or foodstuff. A portioning device known from EP 0 818 148 B1 includes a forming plate in which there are number of depressions or recesses. The mass may be filled into these depressions or recesses, after which it may be compacted and divided by a pressing and stripping device so that it completely fills the recesses or depressions. Following this, the thus portioned product is ejected onto a conveyer belt by a plunger, or is released from the forming plate by lifting the latter from a conveyor belt, and may be delivered to further processing steps by moving the conveyor belt. The device described above is used in particular to produce portioned meat products for preparing hamburgers, meat patties and the like.

A disadvantage of the known method is that in order to shape the patty completely and uniformly it is necessary to put an excess of meat product into the recess or depression and afterward to use a stripping device to remove this excess product, in order to thereby simultaneously achieve a smooth surface of the patty and a portion measurement. Because of the requisite hygienic requirements it is too complex to recover the stripped-off product material, so that this excess stripped-off product is regularly discarded. That results in a disadvantageous loss of product, which leads to elevated normally and production costs. Furthermore, to conserve resources it is necessary to avoid unnecessary losses of foodstuffs.

The known devices also have the disadvantage that to produce meat products of differing dimensions it is necessary to make forming plates with recesses or depressions of the corresponding dimensions. These forming plates are complex to manufacture and therefore cause high production costs.

An additional disadvantageous property of the known device is that a lubricant is normally needed in the stripping process and soiling of the forming plate and the entire device occurs, necessitating complex cleaning of these components. To this end, water is constantly conveyed to the area of the forming plate and stripping device as a lubricating and cleaning liquid, in order to rinse off product residue. This is relatively inefficient and “unclean.” The cleaning is also cost-intensive and causes additional loss of the product being portioned.

The present invention was therefore based on the problem of providing a portioning device and a filling device which allow material-saving portioning of products, as known devices.

### SUMMARY

The problem is solved according to the present invention by a portioning device of the type named at the beginning, which includes a cutting device for portioning the mass filled into the forming space, having a cutter that is introducible at least part way into the forming space.

The introduction of a cutter into the forming space achieves the formation of a portion of mass or product while reducing product waste, since the necessity of stripping off excess product material is avoidable as a result. After detachment by the cutter the product portion can remain initially in the forming space, and is supported by the walls that delimit the forming space. The mass is then conveyed further, and at the next portioning the product portion is ejected in order to be delivered to further processing. It has also turned out that a constant supply of a cleaning liquid during operation can be dispensed with, leading to a “cleaner” process and lower operating costs.

A first advantageous embodiment is distinguished by the fact that the cutter is introducible into the forming space in a direction that is approximately perpendicular to the direction in which the foodstuff is filled into the forming space. The plane in which the cutter moves is thus perpendicular to the direction in which the product is introduced into the forming space. This simplifies the production of slice-shaped product portions. The use of a cutter that is introducible into the forming space approximately perpendicular to the direction in which the foodstuff is filled into the latter also permits largely continuous operation of the portioning device of the present invention, as a further advantage over the existing art. Here product is filled into the forming space in a repetitive manner, is portioned by cutting by introduction of the cutter, and finally is ejected from the forming space by repeated filling of product. The invention is especially well suited in particular for producing uniform portions of ground meat.

In another advantageous embodiment, the forming space has a filling opening through which the product may be filled into the forming space. In this design, the product is therefore filled in through a different opening than the output opening through which the product portions may be output. This embodiment is particularly advantageous in connection with the introduction motion of the cutter described earlier that takes place perpendicular to the direction of filling, in order to achieve a rapidly timed throughput operation of the portioning device.

In another advantageous embodiment, the forming space has a geometry that is matched to the shape of the end product, in particular a geometry whose cross-section is essentially rotationally symmetric, or in particular a geometry that corresponds to the geometry of spare-ribs. However, the forming space can of course assume other shapes, practically without restriction, in order to be able to portion product portions in any desired shape. In this design, the forming space may be further adapted for example to the contour of the patties (with respect to a top view) for hamburgers or to the contour of spare-ribs (with respect to their cross section) or (chicken) nuggets or bars having an essentially rectangular cross section, resulting in shaping and portioning of the product close to the final contours. That makes it possible to eliminate subsequent processing steps in which aftershaping is performed, making efficient production possible.

It is also advantageous for the forming space to be formed within a tube through which the product is axially transportable. That achieves good shaping of the product during transporting, and at the same time easy cleaning of the device. In particular, in this embodiment the product portion can continue to be transported a distance within the tube, and is thereby supported and further shaped if necessary even after the portioning. Furthermore, such a tube may easily be produced and exchanged, for example in order to achieve different product shapes or sizes.

In another advantageous embodiment, the wall that delimits the forming space has a slit into which the cutter is introducible. The slit preferably has a width that slightly exceeds the thickness of the cutter, so that the cutter may be introduced readily into the slit, and escape of parts of the product through the slit is also avoided. The longitudinal direction of the slit is preferably oriented perpendicular to the direction in which the detached product portion is outputtable from the forming space.

The forenamed embodiment is further refined by having the slit extend far enough so that the cutter is able to completely cut through the cross section of the forming space. The dimensions of the slit are determined primarily by the form of motion performed by the cutter when it is introduced through the slit into the forming space and according to the dimensions of the cutter and the forming space. If the cutter is introduced with an approximately uniaxial, translational motion, then in order to completely cut through a product located in the forming space it must normally have a longitudinal dimension that at least corresponds to the dimension of the forming space transverse to the direction of motion of the cutter in the cutting plane. Consequently, in this case the slit must also have at least a corresponding longitudinal dimension, to enable the cutter to completely cut through.

Another advantageous embodiment of the present invention is a portioning device in which the cutter is introducible into the forming space of a place such that a portion of the mass that is formed, when the cutter is introduced, is supported by at least part of the wall. In this embodiment, if the cutter is introducible into the forming space through a slit, as described above, the appropriate place is determined by the position of the slit. It is advantageous for the portion of food to be supported by at least part of the wall section, in order to prevent deformation of the product portion when the cutter is introduced. It is particularly advantageous for the product portion to supported on all sides, if possible, when the cutter is introduced. At the same time there may be provision for parts of the wall section to be moved away, for example pivoted or shifted, to remove the product portion. The necessary measure of support of the product portion must be matched in particular to the consistency and hardness of the product being portioned.

The forenamed embodiment may be refined in an advantageous way by locating the slit at a distance from the output opening such that there is a section of the forming space between these openings which corresponds approximately to the size of the product portion. In this design it is possible for example for exactly one product portion to be formed between the insertion opening, i.e. for example the slit, and the output opening, when the cutter is introduced into the forming space. During the cutting process this portion is then supported by the walls of the forming section between the forenamed openings, and can be removed/ejected after the cutting process is ended. This removal or ejection of the product portion is especially simplified by the advantageous spacing of the output opening from the slit.

The portioning device according to the present invention may be further refined by having the wall delimiting the forming section cylindrical and having the slit almost completely penetrate the wall. Here the slit may for extend for example around some 180°-350°, particularly preferably 210°-350° of the circumference of the wall, thereby enabling an especially simple introductory motion of the cutter. At the same time, such a design of the slit allows especially easy cleaning of the portioning device according to the present invention, which is particularly advantageous if the portioning device is used for portioning foodstuffs.

Another advantageous embodiment is distinguished by the fact that the introductory motion of the cutter into the forming space takes place in a plane. In this way, a smooth and flat cutting edge of the product portion that is desired in many applications is achieved. Furthermore, the motion of the cutter is simplified; it may occur for example as rotation around a fixed axis or as translation.

The cutter may be designed advantageously as a two-bladed rotatable knife. This embodiment is especially preferable if the cutter is to be introduced into and removed from the forming space without a change of direction, i.e. in particular if the dimensions of a slit through which the cutter is introducible (and removable) are such that the cutter, coming from a first direction, can enter the forming space through the slit, and then, as the rotational motion continues, can emerge from the forming space again in a second direction through a different section of the slit. This enables the service life of the cutter to be increased, since the knife has two blades and merely a rotation of 180° is necessary for a portioning and severing process. In addition, designs with more than two blades are also advantageous for certain applications, in particular when products are to be portioned that require high cutting power and cause high wear of the cutter.

Another advantageous embodiment of the portioning device according to the present invention is characterized by a portioning device with a forming space delimited by a wall section for forming the mass and into which the mass can be filled and an output opening through which the portioned masses can be input, and a cutting device for portioning the mass filled into the forming space and that has a cutter that can be introduced at least partially into the forming space. Here the means of attachment may include in particular a connecting flange, which allows attachment for example by means of a bayonet fastener, threaded fastener, clamp or the like. In this way, the portioning device according to the present invention can operate in direct combination with a transporting and mincing device, such as a filling machine for sausage meat or a meat grinder, or a filling machine with a meat grinder connected in line. At the same time it is also possible to provide for the motion of the cutter to be controlled depending on the transport/mincing performance of the linked device, for example by mechanically coupling the transport/mincing mechanism of the device with the cutting device, or through a control unit that registers or controls the transport/mincing performance and intermittently controls the motion of the cutting device accordingly. In particular when the cutting device according to the present invention is positioned downline from a meat grinder, and when the cutting plane of the knife of the cutting device is positioned at a right angle, an additional advantage comes from the fact that the orientation or structure of the meat that develops in the meat grinder remains largely intact even after separation by the cutting device, so that the product has a better texture or structure compared to conventional production methods.

An additional aspect of the present invention is a device for transporting and/or mincing products, in particular meat products, which includes a portioning device according to one of the designs explained above.

The transporting and/or mincing device of the forenamed type may be further refined by a smoothing belt that is able to receive the portioned product, and which works together with at least one shaping surface to aftershape the portioned product.

In this design, an unwanted deformation of the product which may occur in the cutting process is corrected. In addition, this design is suited for producing product portions with very exact and smooth surfaces. The product is transported on the smoothing belt and pressed between the smoothing belt and a shaping surface, and/or is inserted by the smoothing belt between two approximately opposing shaping surfaces and moved along them in order to achieve aftershaping of the portioned product.

Another advantageous embodiment has means of transport for transporting the product, for example in the form of a rotary vane pump or double screw pump, where the means of transport may be operated discontinuously and the timing of the discontinuous operation works in combination with the introductory motion of the cutter into the forming space. In this refinement, the means of transport may thus fill the forming space with product in a first transport process of a first timing phase, and this product may then be detached and thus portioned by introducing the cutter. In the next phase the forming space may then be filled again by the means of transport, whereby the product portion detached earlier is ejected from the forming space through the output opening. The product inserted in the second phase is in turn portioned through severing by the cutter, and another phase can begin. The interaction is preferably realized by a controller.

The device according to the present invention operates advantageously according to a method for portioning products, in particular meat products, having these process steps: filling of the product into a forming space, output of the portioned product through an output opening of the filling and forming space, where a cutter of a cutting device is introduced into the forming space between the filling and output for the purpose of portioning. After being output, the portioned product may be transported on a shaping belt, and aftershaped on the shaping belt through the interaction of at least two shaping surfaces.

### BRIEF DESCRIPTION OF THE DRAWINGS

A preferred embodiment of the present invention will be described with reference to the figures.

FIG. 1 shows a schematic top view of a filling machine with a meat grinder and a flange-mounted portioning device according to the present invention,

FIG. 2 shows a partially cut-away detailed view of FIG. 1 depicting a forming space,

FIG. 3 shows a front view of the area of the shaping space from the direction identified by the arrow in FIG. 2,

FIG. 4 shows a front view of the cutter, and

FIG. 5 shows a top view of the cutter of FIG. 4.

### DETAILED DESCRIPTION

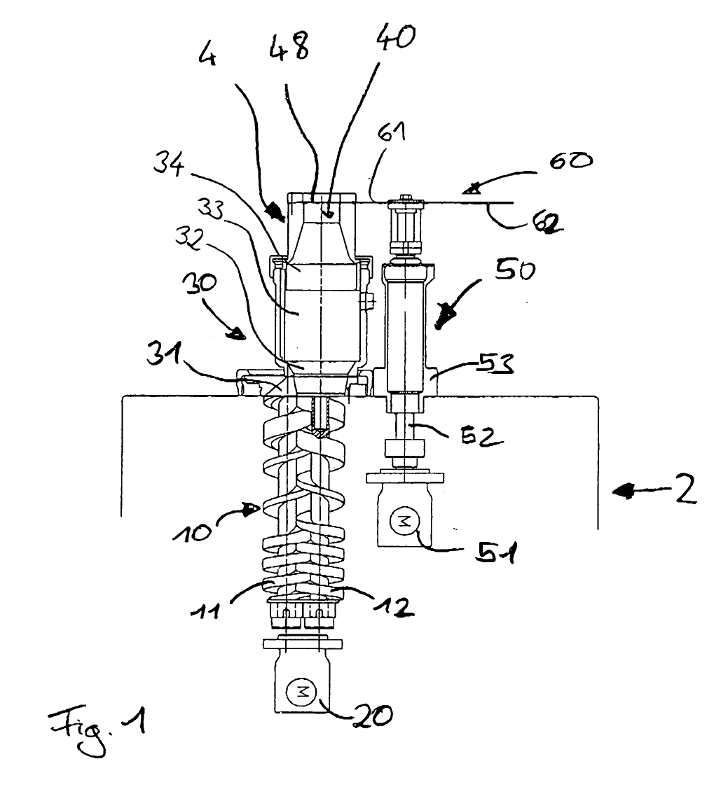

The partially depicted filling machine 2 with linked meat grinder according to FIG. 1 has a transporting device having a transport area 10 with two feed screws 11, 12 that are rotatable in opposite directions, which are driven by a motor 20. Motor 20 may be for example a hydromotor or an electric motor, and is positioned at a drive end of the feed screws 11, 12. At the end opposite the drive end, a meat grinder 30 is coupled to the filling machine 2. At its end facing the feed screws 11, 12 this grinder 30 has a receiving funnel 31, which becomes narrower conically in the direction of transport, starting from the end of the feed screws 11, 12.

Instead of the drive device in the form of the driven feed screws, other transport devices familiar to the person skilled in the art, such as feed pumps, rotary vane pumps or the like are advantageous for certain applications.

The receiving funnel 31 connects to a housing-like tube section 32, 33. Tube section 32, 33, viewed in the transport direction, has first a conical enlargement 32, followed by a cylindrical section 33 of constant cross section. In a manner that is not shown, inside the housing-like tube sections 32, 33 of the grinder 30 there are perforated disks and rotating knives which are coupled with one of the feed screws 12, so as to be driven by the motor 20.

Attached to the end 34 of the tube section 32, 33 opposite the conical expansion 32 is a portioning device 4, which is described in greater detail below.

A cutting device 50 is positioned to the side of the feed screws 11, 12 and the transport tube 30, with the portioning device attached to it, and is attached to the filling machine 2. The cutting device 50 includes a hydromotor or electric motor 51, whose axis of rotation is parallel to the axis of rotation of motor 20 and of screws 11, 12. Motor 51 drives a connecting shaft 52. Connecting shaft 52 is rotatably mounted in a bearing housing 53. A cutter in the form of a cutting knife 60 is removably attached to the end of connecting shaft 52 opposite motor 51.

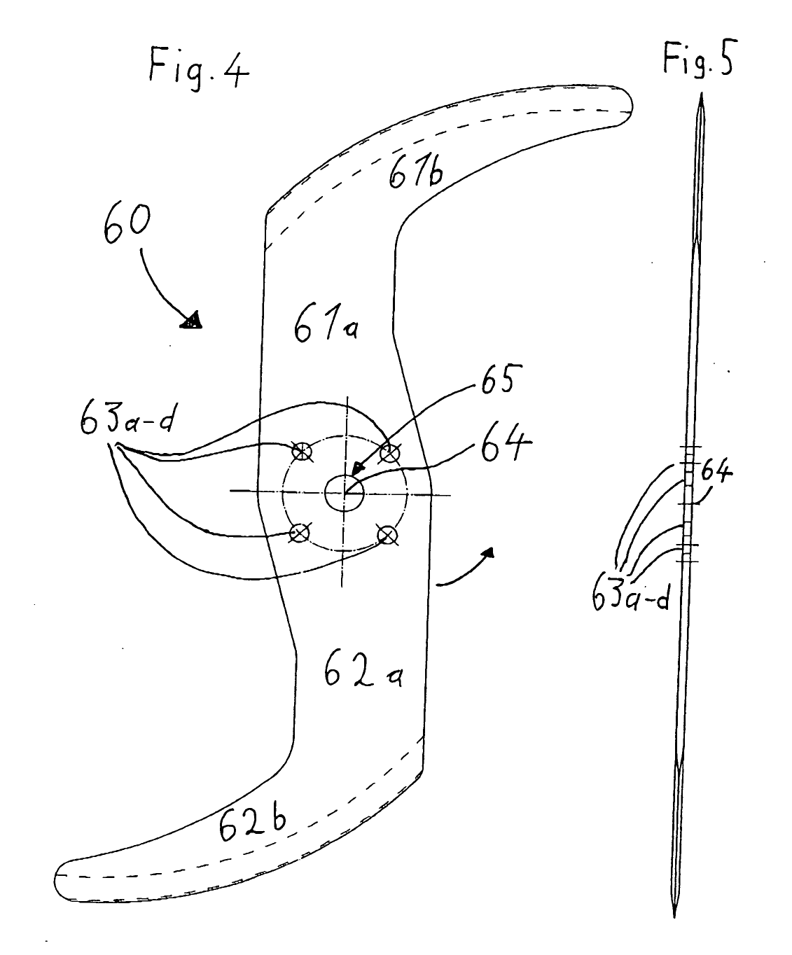

The cutting knife 60 shown in FIG. 4 has two cutting blades 61, 62 offset from each other by 180°. Cutting knife 60 is attached to connecting shaft 52 by a plurality of screws (not shown) which are positioned parallel to and at a distance form the axis of rotation of connecting shaft 52. Alternatively, cutting knife 60 may be joined to the connecting shaft by other attachment methods, for example by a bayonet fastener or other quick-lock couplings, in order to permit quick replacement of the cutting knife.

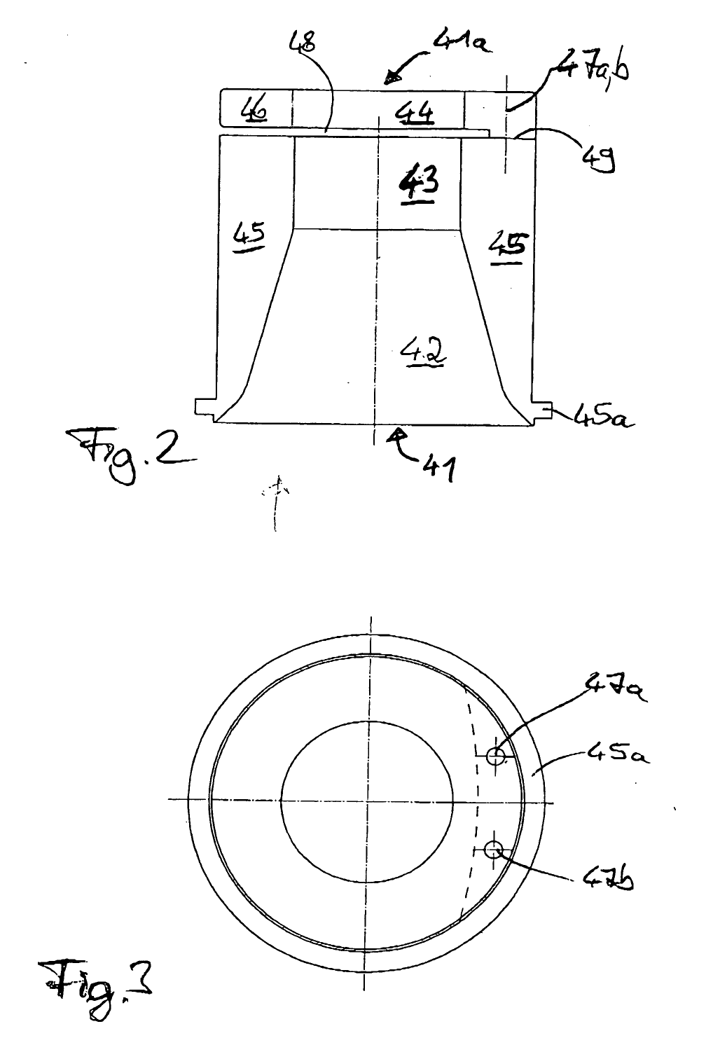

The forming space 40 of portioning device 4 has a first forming space section 42 that decreases in size conically from a filling opening 41 in the direction of transport, as can be seen clearly in particular from FIG. 2. Connected to the first forming space section 42 in the direction of transport is a second, cylindrical forming space section 43. Connected in turn to this second forming space section in the direction of transport is a third forming space section 44, which is also cylindrical and whose diameter is somewhat larger than that of the second forming space section 43.

The length of the second forming space section 43 in the direction of transport of the product must be long enough so that adequate shape stability of the mass or product results, so that after leaving forming space section 43 the product changes its cross section only slightly or not at all and essentially retains the cross section of forming space section 43. The requisite length of the second forming space section 43 for this shape stability depends in particular on the degree of reshaping of the product within the first forming space section 42 or upon passing from the first forming space section 42 into the second forming space section 43, on the material properties of the product, and on the transport speed. In principle, with increasing degree of reshaping, increasing transport speed and increasing elasticity, depending on the portion size, a greater length must be chosen for the second forming space section 43. The length must not be increased without limits, however, since with greater lengths the properties of the product are changed negatively for example as a result of strong condensing and pressing.

First and second forming space sections 42, 43 are delimited by an essentially rotationally symmetrical wall 45. In the area of filling opening 41 the wall 45 has a ridge running around its outer periphery, which is used for simple and rapid attachment of the portioning device 4 to a meat grinder 30 or directly to a filling machine 2.

The third forming space section 44 is delimited by a cylindrical wall 46, which is attached to the wall 45 by a screw (represented schematically by broken line 47a, b) which may be screwed in parallel to and contrary to the direction of transport. Alternatively, walls 45 and 46 may also be made as a single piece. Wall 46 has a cutout 48 at its surface which is directed toward wall 45. When wall 46 is attached to wall 45, this forms a slit 48 between the second and third forming space sections, which extends along the entire boundary surface between walls 45, 46 except for a small area 49. In particular, the slit 48 extends over the entire cross section of forming space sections 43, 44. An output opening 41a is formed from the side of the second forming space section 44 opposite the slit.

FIG. 3 shows a view of the forming area according to FIG. 2 in a top view of filling opening 41. In it the schematically drawn (actually not visible) bored holes 47a, b may be recognized, which are used to attach wall 46 to wall 45.

As can be seen clearly from FIGS. 4 and 5, the cutting knife 60 of cutting device 50 is attached to connecting shaft 52 by four screws, which may be inserted through holes 63a-d. Holes 63a-d are spaced at a distance from the rotational axis of connecting shaft 52, which coincides with the rotational axis 64 of the cutting knife, and are offset from each other by 90°. In this way it is possible to transfer a high torque from connecting shaft 52 to cutting knife 60.

Between blade sections 61a, 62a, and concentric to the axis of rotation 64, cutting knife 60 has a hole 65 which is used to center the cutting knife on connecting shaft 52.

Cutting knife 60 has two cutting blades 61, 62, which are formed rotationally symmetrical in relation to the axis of rotation 64. Each cutting blade 61, 62 has a first blade section 61a, 62a, which extends in a straight line and radially to the axis of rotation 64. First blade section 61a, 62a passes over into a second blade section 61b, 62b, which extends at an angle from the first blade section 61a, 62a. Cutting blade 60 rotates counterclockwise in the view in FIG. 4.

The grinding of the cutting knife, represented by the broken lines in FIG. 4 and FIG. 5, points toward the forming space in the direction of rotation and is symmetrical, so that no lateral, axial forces in reference to the axis of rotation 64 are exerted on the product mass and the cutting knife.

The thickness of the cutting knife 60 shown in FIG. 5 determines the depth of the recess 48 or the width of the slit 48 that is formed between wall sections 45, 46. To ensure easy introduction of cutting knife 60 into space 42, 43, 44, this slit 48 must have a slightly greater dimension than the thickness of cutting section 61b, 62b of cutting knife 60.

Cutting sections 61b, 62b of cutting knife 60 should be as thin as possible to achieve good cutting results. However, the thickness of cutting sections 61b, 62b and of the cutting knife must be great enough to ensure adequate stability of the knife as it cuts through the product. The thickness of cutting sections 61b, 62b and of the cutting knife must therefore be matched to the material properties of the product, and must be greater, the harder or more non-homogeneous the product is.

The invention operates as follows:

A product such as pasty sausage meat is transported by feed screws 11, 12 from a filling hoper, not shown, into the grinder 30 (see FIG. 1), where it is ground fine. The sausage material passes through filling opening 41 into the shaping space 40 of portioning device 4, and after flowing through the conically reduced first forming space section 42 into the second forming space section 43 is brought there to the desired shape, in the exemplary embodiment a cylindrical shape. Alternatively, however, deviating shapes such as elliptical, rectangular or square shapes of the forming space 40 are also possible. By means of the cutting device 50, which is intermittently controlled and driven by a central control unit, not shown, by passage of the cutting blades 61, 62 through slit 48 the product is completely cut through and thereby portioned. In the further process, in the area of the section 44 that follows the slit in the direction of flow a product portion thus separated is first supported by the wall 46 there. Because of the intermittent further transport of the following sausage material, this product portion is then ejected from section 44 through the output opening 41 with the help of the feed pump, and falls onto a conveyor or transport belt.

1. A portioning device for portioning a bulk material, comprising:
a forming space adapted to be filled by a mass of the bulk material, the forming space delimited by a wall for forming the mass and
an output opening; and
a cutting device for portioning the mass filled into the forming space into a plurality of mass portions, the cutting device having a cutter that is at least partially introducible into the forming space and each of the plurality of mass portions being output through the output opening.

2. The portioning device of claim 1 wherein the cutting body is introducible into the forming space in a direction that lies approximately perpendicular to the direction in which the mass is filled into the forming space.

3. The portioning device of claim 1 wherein the forming space has a filling opening through which the mass can be filled into the forming space.

4. The portioning device of claim 1 wherein the forming space has a geometry matched to the form of an end product.

5. The portioning device of claim 4 wherein the forming space is defined inside a tube through which the mass is axially transportable.

6. The portioning device of claim 1 wherein the wall delimiting the forming space has a slit into which the cutter can be introduced.

7. The portioning device of claim 6 wherein the slit extends far enough so that the cutter can cut completely through the cross section of the forming space.

8. The portioning device of claim 7 wherein the cutter is introducible into the forming space at a place such that each of the plurality of mass portions formed, when the cutter is introduced, is supported by at least part of the wall.

9. The portioning device of claim 8 wherein the slit is spaced at a distance from an output opening of the forming space such that a section of the forming space that corresponds at least approximately to the size of each of the plurality of mass portions.

10. The portioning device of claim 8 wherein the wall delimiting the forming space is substantially cylindrical and the slit almost completely penetrates the wall.

11. The portioning device of claim 1 wherein the cutter is a two-bladed, rotatable cutting knife.

12. The portioning device of claim 1 further comprising a means for fastening cutting device as an attachment to a device for transporting and/or mincing bulk material.

13. A device for transporting and/or mincing bulk material, comprising:
a forming space adapted to be filled by a mass of the bulk material, the forming space delimited by a wall for forming the mass and
an output opening; and
a cutting device for portioning the mass filled into the forming space, into a plurality of mass portions, the cutting device having a cutter that can be introduced at least partially into the forming space and each of the plurality of mass portions being output through the output opening.

14. The device of claim 13 further comprising:
a smoothing belt that can receive the plurality of mass portions, the smoothing belt cooperating with at least one shaping surface to aftershape each of the plurality of mass portions.

15. The device of claim 13 further comprising:
means for transporting the mass, the means of transport being discontinuously operable, and the timing of the discontinuous operation cooperating with the introductory motion of the cutter into the forming space for portioning the mass into the plurality of mass portions.

16. The portioning device of claim 4 wherein the geometry has a cross-section that is substantially rotationally symmetrical.

17. The portioning device of claim 4 wherein the geometry has a cross-section that is oval.
